(19) United States
(12) Patent Application Publication
(10) Pub. No.: US 2026/0328175 A1
(43) Pub. Date: Oct. 22, 2026

(54) VEHICLE BATTERY JUMP-START SYSTEM

(71) Applicant: Chanc Williams, Hogansville, GA (US)

(72) Inventor: Chanc Williams, Hogansville, GA (US)

(21) Appl. No.: 19/184,512

(22) Filed: Apr. 21, 2025

(51) Int. Cl. F02N 19/00; B60R 16/02; B60R 16/033; H02J 1/00

(52) U.S. Cl. CPC F02N 19/001; B60R 16/0215; H01M 10/425; H01M 50/296; H01R 33/05; H02J 1/00; H02J 7/00; B60R 16/033

(57) ABSTRACT

A vehicle battery jump-start system configured for installation inside a vehicle may include a permanently installed high-current power pathway including a two-part positive cable and a ground cable, each constructed from 2-gauge wire, wherein the two-part positive cable comprises split positive cable routing at a fuse holder to a starter, and wherein the grounding cable is in direct contact with an engine block or a negative battery cable; a fuse assembly providing overcurrent protection rated to 125 amps or higher; a mechanically keyed connector configured to prevent reverse polarity connection; a quick disconnect coupling mounted within the vehicle cabin; and a portable power supply interface configured to provide direct power to the vehicle's starter system without requiring battery access, wherein the system enables a user to initiate a jump-start of the vehicle from the interior without hood access.

### TECHNICAL FIELD

The embodiments generally relate to systems and methods for interior-accessible vehicle battery jump-starting.

### BACKGROUND

Conventional vehicle battery jump-starting systems typically rely on external access to the vehicle's engine compartment. These systems require the user to raise the hood, locate the battery, and attach jumper cables or a portable power supply to the appropriate terminals. In many cases, users must depend on another vehicle to supply the necessary power, which involves coordinating cable connections between two vehicles parked in close proximity. Such procedures often occur in uncontrolled environments, such as roadside shoulders or busy parking lots, where safety and accessibility are concerns.

Portable jump starters and quick boost devices have gained popularity as standalone alternatives to traditional jumper cables. These units generally consist of a rechargeable battery pack equipped with output terminals and clamps that connect directly to the vehicle's battery. Some models feature built-in safety mechanisms, such as reverse polarity protection or voltage monitoring, and may include additional functions such as lights or USB charging ports. Although these devices eliminate the need for another vehicle, they still require physical access to the battery terminals, which may be difficult to locate, especially in modern vehicles with tightly packed engine bays or covered battery compartments.

Various in-vehicle charging ports, such as 12-volt cigarette lighters or onboard diagnostic connectors, have been used to provide low-current trickle charging solutions. These methods generally require extended charge times and may be ineffective if the vehicle's battery is deeply discharged. In addition, reliance on the vehicle's internal circuitry for power transfer limits the system's capacity to deliver the high current necessary for engine cranking. While some devices allow partial charging through these ports, they are not suitable for immediate engine start-up and often fail in extreme temperatures or with completely drained batteries.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

A vehicle battery jump-start system enables interior-accessible vehicle starting functionality through a permanently installed, high-current power pathway. The system includes a two-part positive cable and a ground cable, constructed from 2-gauge wire, routed from the battery to a strategically located in-cabin interface. A quick disconnect assembly and mechanically keyed connector prevent reverse polarity connections, while a fuse assembly rated at 125 amps or higher provides overcurrent protection. By eliminating the need for hood access, the system provides a safe and immediate solution for initiating a jump-start from inside the vehicle.

The system includes a portable power supply interface configured to deliver direct cranking power to the starter motor. In some embodiments, this interface is mounted within the vehicle cabin—often near the knee bolster for safety and accessibility—and is operable by the user without exiting the vehicle. In other embodiments, the system may be installed during assembly of a new vehicle. The system can accommodate both gasoline and diesel engines, with current handling capabilities ranging from 130 to 700 amps. The fuse is positioned within 12 inches of the battery terminal to enhance safety and reduce voltage drop.

Additional features of the system may include a spring-loaded safety cover on the quick disconnect, a built-in voltage meter for real-time power monitoring, and an optional solar charging port to maintain readiness of the portable power supply. The design ensures compatibility with lithium-ion battery packs rated from approximately 6000 amps to 10,000 amps, enabling rapid and powerful jump-starting.

The system can be installed discreetly behind existing vehicle trim panels and is designed for completion by a professional technician in under 15 minutes. Mechanically keyed connectors are incorporated to ensure the correct orientation of connections, effectively reducing the risk of damage to sensitive electronic components. The connector system prevents accidental misuse and contributes to a fail-safe operation under emergency conditions.

A method of using the system allows a user to jump-start the vehicle by connecting a portable power supply to the interior interface without accessing the engine bay. This bypasses common obstacles associated with conventional systems, such as locating battery terminals or relying on other vehicles. The system also includes a jump-start installation kit with all necessary cables, connectors, fuse assemblies, and optional components for seamless retrofit into a variety of vehicle makes and models.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a block diagram of a vehicle battery jump-start system configured for interior operation, according to some embodiments; and

FIG. 2 illustrates a flow diagram representing a method for jump-starting a vehicle using an interior-accessible battery starting system, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

A vehicle battery jump-start system may include a permanently installed high-current power pathway that allows a user to initiate a vehicle start from inside the cabin, bypassing the need to access the vehicle's battery compartment. The system may be adapted for installation in a wide variety of applications, including cars, trucks, recreational vehicles, ATVs, tractors, boats, generators, and any other system with an electrical starting mechanism.

The power pathway may include a two-part positive cable assembly and a ground cable, each constructed from 2-gauge wire or larger. The cable length may be a minimum of six feet, though longer cables may be used depending on the make and model of the vehicle. In configurations for diesel vehicles, the positive cable may split into three branches at a fuse holder to support routing from the battery to the vehicle's starter. The ground cable may be connected directly to the engine block or, in certain applications, to the vehicle frame if the negative battery terminal is bonded to the frame. This grounding configuration ensures continuity and the ability to carry the high current required for engine cranking.

A fuse assembly may be positioned in-line with the positive cable to provide overcurrent protection. The fuse may be rated at 125 amps or higher, depending on the specific vehicle application. For larger diesel engines, the fuse rating may be increased to 250 amps or more to accommodate higher starting current demands. The fuse may be installed within 12 inches of the battery terminal to reduce the risk of voltage drop and ensure rapid circuit protection in the event of a fault.

The system may further include a quick disconnect coupling mounted inside the vehicle cabin. This coupling enables the user to easily connect an external portable power source without opening the hood. The quick disconnect may be protected by a spring-loaded safety cover to reduce the risk of accidental contact or contamination when not in use. A mechanically keyed connector ensures that the interface may only be connected in the correct polarity orientation, thereby preventing damage to onboard electronics or the power supply.

The connector interface may be mounted in a location that is easily accessible to the user, such as near the knee bolster, lower dashboard, or side panel, depending on available space within the vehicle. The design supports collision safety by minimizing the likelihood of connector intrusion into the passenger compartment. The system may also include a built-in voltage meter to allow the user to monitor system readiness before initiating a jump-start.

A portable power supply, such as a lithium-ion battery pack, may be configured to interface with the cabin-mounted connector. The power pack may be rated for at least 6000 amps for gasoline engines, including those with up to 7.5-liter V10 displacement. Diesel engines may require a power pack capable of delivering 10,000 amps or more due to higher compression and starting resistance. The power supply may be rechargeable and optionally include a solar charging port to maintain its charge while in storage.

To support a range of operational scenarios, the system may feature a two-part modular cable structure. Part 1 of the cable may be permanently mounted inside the vehicle and terminate in a high-amperage quick connector (rated at 350 amps or higher). Part 2 may be a detachable section with a mating quick connector, which terminates in traditional battery clamps. This configuration may be used to jump-start the battery directly if the installed fuse fails, allowing for a backup connection path through the battery terminals.

The installation process for the system may involve routing the positive and negative cables from the battery terminals through factory openings in the vehicle frame, firewall, or body panels. If no existing path is available, the installer may drill access holes and insert rubber grommets to protect the cables from abrasion or moisture intrusion. The system may be installed by individuals with general mechanical knowledge or by following printed or video installation guides. While a professional installation is recommended for custom vehicle configurations, most installations may be completed in approximately 15 minutes.

The system may be concealed behind existing interior or under-hood trim panels, providing a clean and factory-like appearance. Once installed, the user may connect the portable power pack to the cabin-mounted interface to immediately initiate the vehicle's starter motor, bypassing the need for hood access or assistance from another vehicle. The system is particularly useful in scenarios where the battery is not easily accessible or when weather, safety, or location make exiting the vehicle undesirable.

A jump-start installation kit may be provided to enable universal application of the system. The kit may include at least one 2-gauge cable of six feet or longer, a fuse rated between 120 and 250 amps depending on vehicle requirements, a fuse holder, cable grommets, quick disconnect assemblies, and mechanically keyed connectors. The kit may optionally include solar charging hardware, interior trim mounting brackets, and printed instructions tailored to common vehicle types. The connectors, wiring, and components may be rated for automotive environments, including resistance to vibration, heat, and corrosion.

In use, the system may enable a user to perform a jump-start by simply connecting a portable power supply to the interior connector. This bypasses the need to raise the hood, locate the battery, or work in potentially unsafe or inconvenient conditions. When the power supply is engaged, high-current flows through the permanently installed pathway to the vehicle's starter, enabling the engine to crank and start as if the original battery were fully charged.

This configuration may be particularly effective in environments such as fleet management, off-road recreation, or emergency response, where rapid and self-contained battery starting solutions are needed. The system's modularity and installation flexibility also allow it to be adapted for other battery-based systems beyond automobiles, such as marine engines, construction equipment, or RV power systems.

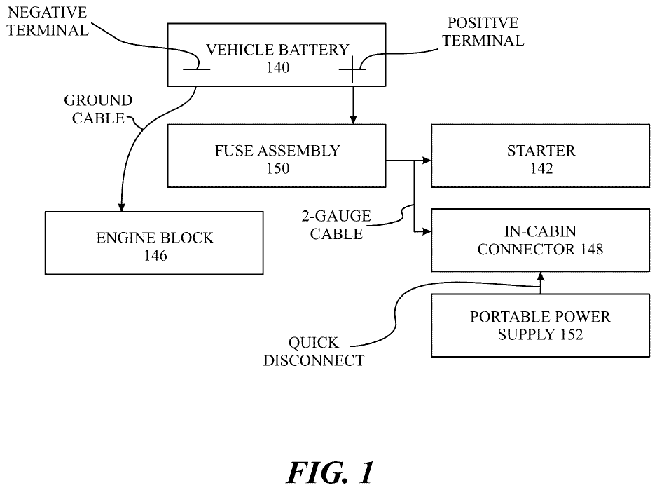

FIG. 1 illustrates a block diagram of a vehicle battery jump-start system configured for interior operation. The system includes a vehicle battery 140 having a positive terminal and a negative terminal, with a high-current 2-gauge cable routed from the positive terminal to a fuse assembly 150. The fuse assembly 150 provides overcurrent protection and may be rated at 125 amps or higher depending on the application. From the fuse assembly 150, the positive cable may split into separate branches, one of which connects directly to the starter 142, while another is routed to an in-cabin connector 148 mounted within the vehicle interior. This in-cabin connector 148 may include a quick disconnect interface and may optionally incorporate a voltage meter and a spring-loaded safety cover. A ground cable 146 connects the battery's negative terminal to the engine block, enabling a complete high-current circuit suitable for cranking. In alternative configurations, the grounding connection may be made to the vehicle frame, provided the frame is bonded to the battery's negative terminal. The system may be energized via a portable power supply 152, which connects to the in-cabin connector 148. When connected, current from the portable power supply 152 is delivered through the permanently installed cable pathway to the starter 142, allowing the vehicle to be jump-started without accessing the battery directly. This configuration permits the user to initiate a jump-start entirely from within the vehicle cabin.

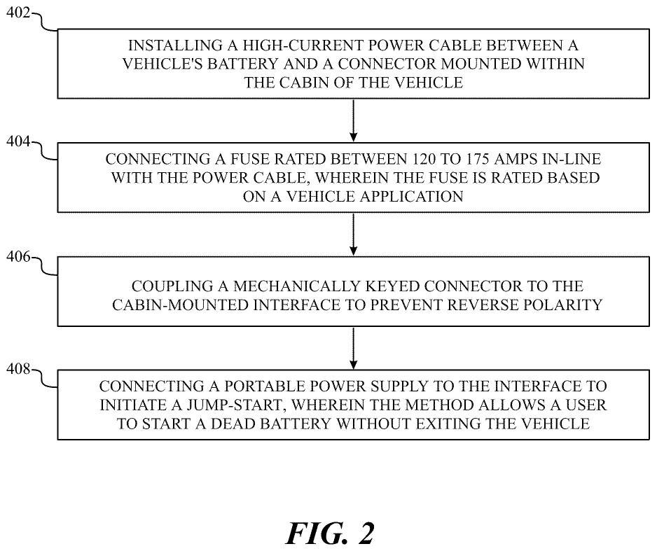

FIG. 2 illustrates a flow diagram representing a method for jump-starting a vehicle using an interior-accessible battery starting system. The method begins at step 402, which involves installing a high-current power cable between a vehicle's battery and a connector mounted within the cabin of the vehicle. This cable may be a 2-gauge or similarly rated conductor suitable for carrying starter-level current, and it may be routed through the vehicle's firewall or other structural components, optionally using grommets to protect the cable at penetration points. At step 404, the method includes connecting a fuse rated between 120 and 175 amps in-line with the power cable, wherein the selected fuse rating is based on the specific electrical requirements of the vehicle. In some applications, such as those involving diesel engines, the fuse rating may be increased to 250 amps or more. Step 406 shows the step of coupling a mechanically keyed connector to the cabin-mounted interface. The keying mechanism ensures proper polarity alignment, preventing reverse polarity connections that could damage vehicle electronics or the power source. Step 408 represents the action of connecting a portable power supply to the interface to initiate a jump-start. Once connected, the power supply delivers high-current directly to the vehicle's starter circuit via the pre-installed power pathway. This method enables a user to start a vehicle with a depleted battery without exiting the vehicle or accessing the engine compartment, thereby improving ease of use and safety during emergency situations.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A vehicle battery jump-start system configured for installation inside a vehicle, the system comprising:
a permanently installed high-current power pathway including a two-part positive cable and a ground cable, each constructed from 2-gauge wire, wherein the two-part positive cable comprises split positive cable routing at a fuse holder to a starter, and wherein the grounding cable is in direct contact with an engine block or a negative battery cable;
a fuse assembly providing overcurrent protection rated to 125 amps or higher;
a mechanically keyed connector configured to prevent reverse polarity connection;
a quick disconnect coupling mounted within the vehicle cabin; and
a portable power supply interface configured to provide direct power to the vehicle's starter system without requiring battery access, wherein the system enables a user to initiate a jump-start of the vehicle from the interior without hood access.

2. The system of claim 1, wherein the connector is mounted on or near the vehicle's knee bolster for easy access and collision safety.

3. The system of claim 1, wherein the quick disconnect assembly includes a spring-loaded safety cover.

4. The system of claim 1, wherein the portable power supply is a lithium-ion battery pack rated for approximately 6000 amps to approximately 10,000 amps.

5. The system of claim 1, wherein the connector interface includes a built-in voltage meter for real-time monitoring.

6. The system of claim 1, further comprising a solar charging port for recharging the portable power supply.

7. The system of claim 1, wherein the mechanical keying prevents physical mating unless correct polarity orientation is maintained.

8. The system of claim 1, wherein the entire system is installed in under 15 minutes by a professional technician.

9. The system of claim 1, wherein the power pathway is capable of handling starter currents in the range of 130 to 700 amps.

10. The system of claim 1, wherein the system is compatible with both gasoline and diesel engines.

11. The system of claim 1, wherein the entire system is concealed behind vehicle trim panels for aesthetic purposes.

12. The system of claim 1, wherein the fuse is installed within 12 inches of the battery terminal for optimal protection.

13. A method for jump-starting a vehicle using an interior-accessible system, the method comprising:
installing a high-current power cable between a vehicle's battery and a connector mounted within the cabin of the vehicle;
connecting a fuse rated between 120 to 175 amps in-line with the power cable, wherein the fuse is rated based on a vehicle application;
coupling a mechanically keyed connector to the cabin-mounted interface to prevent reverse polarity; and
connecting a portable power supply to the interface to initiate a jump-start,
wherein the method allows a user to start a dead battery without exiting the vehicle.

14. The method of claim 13, wherein the installation step includes routing the cable through factory openings in the vehicle frame using provided grommets.

15. The method of claim 13, wherein the power supply used is rechargeable and supports multiple jump-start cycles.

16. The method of claim 13, further comprising integrating the solar charging port to maintain power supply readiness.

17. A jump-start installation kit for configuring a vehicle for interior jump-starting, the kit comprising:
at least one 2-gauge minimum power cable with a length of at least 6 feet;
a two-part positive cable assembly comprising a first quick connector rated to 350 amp or higher for an inside of a vehicle and a second quick connector of 350 amps or higher to mate with the 1st cable that will be used with battery cable clamps that will connect directly to a battery if a fuse is damaged;
a 120-175 amp fuse and fuse holder;
a quick disconnect assembly;
at least one mechanically keyed connector;
one or more cable grommets for clean routing through vehicle body panels; and
an optional solar charger port, wherein the kit is adapted for permanent installation and facilitates jump-starting from inside the vehicle.

18. The kit of claim 17, further comprising printed installation instructions for different vehicle models.

19. The kit of claim 17, wherein the fuse holder is rated for vibration resistance and under-hood conditions.

20. The kit of claim 17, further comprising optional mounting hardware for interior trim installation.
